(19) United States
(12) Patent Application Publication
(10) Pub. No.: US 2010/0250381 A1
(43) Pub. Date: Sep. 30, 2010

(54) METHOD AND SYSTEM FOR HANDLING A QUEUE

(76) Inventor: Michael Snyder, Fletcher, NC (US)

Correspondence Address: NIXON & VANDERHYE, PC, 901 NORTH GLEBE ROAD, 11TH FLOOR, ARLINGTON, VA, 22203, US

(21) Appl. No.: 12/594,030

(22) PCT Filed: Mar. 30, 2007
(86) PCT No.: PCT/SE07/50200

§ 371 Date: Apr. 28, 2010

(51) Int. Cl. G06Q 10/00; G08B 5/36; G06Q 30/00

(52) U.S. Cl. 705/21; 340/691.6; 705/346

(57) ABSTRACT

The invention concerns a system designed for handling a queue at store checkouts and similar. Instead of one queue at each check-out counter all counters have one common single-line queue. At the front of the queue there is a display showing the status for each of the checkouts and indicates when the next customer in the queue should proceed to an available counter. The display shows the status of the checkout counters and thereby indicates to the next customer in the queue that it is time to proceed to an available checkout counter. The checkout counters and the central processing units are interconnected such that the display, upon the occurrence of specific triggering events associated with transaction events from a checkout counter, is arranged to automatically indicate a change in status and update the status for said checkout counter. The invention also relates to a method for handling a queue as referred above.

### TECHNICAL FIELD

The invention concerns a system designed for handling a queue at store checkouts and similar. Instead of one queue at each checkout counter all counters have one common single-line queue. At the front of the queue there is a display showing each of the checkouts and indicates when the next customer in the queue should proceed to an available counter. The invention also relates to a method for handling a queue as referred above.

### PRIOR ART

Systems with checkout counter all connected to one common single-line queue are commonly found at for instance airports where passengers are directed to such queues when checking in their baggage and when queuing for the security control. The person standing first in the queue must observe when a counter becomes available and then approach the counter. A task that may be difficult and time consuming when the number of counters connected to one queue is large or when the person who is at the front of the queue is inattentive. Furthermore, the personnel attending the counter often must inform the customers at the front of the queue about the availability causing a stressful situation for the personnel.

A solution to some of these problems is to provide a display at the front of the queue indicating that a counter is available and that the next customer in the queue should proceed to this counter as well as the direction to it. Involvement from the personnel is required in that the cashier must inform the system of his availability. The system also requires attentiveness from the persons in the queue; especially when two or more counters become available with short time intervals between their moments of availability.

### SUMMARY OF INVENTION

The object of the invention is to provide a system with which the queuing becomes more efficient, thereby shortening waiting times.

It is a further object of the present invention to provide a system that increases the automatization and minimizes the involvement of the personnel and also decreases their stress level.

Another object of the invention is to provide a system that requires less attentiveness from the persons standing in the queue.

It is also an object of the present invention to provide a method for handling a queue as referred to above through which one or more of the above mentioned objects can be achieved.

The problem is solved by the present system designed for handling a queue at store checkout counters and similar, wherein two or more checkout counters have one common single-line customer queue and wherein one or more central processing units are arranged to control a display arranged within sight of the queue. The display displays the status of all connected checkout counters and thereby indicates to the next customer in the queue to proceed to an available checkout counter. The checkout counters and the central processing units are interconnected such that the display, upon the occurrence of specific triggering events associated with transaction events from a checkout counter, is arranged to automatically indicate a change in status and update the status for said checkout counter. Specific triggering events associated with transaction events may e.g. be the event when the cashier informs the cash register that all items have been scanned or the event that determines that a transaction is completed. It can furthermore be the event that the first item for a new customer is scanned. Upon the occurrence of specific triggering events the display automatically updates its status and informs the customers accordingly. The system is a helpful tool for the cashier, eliminating a lot of stressful moments in that the cashier does not have to pay any focus on the queue and can fully concentrate on the scanning of items and the interaction with the customer. Furthermore, the queuing times are shortened and less attentiveness is required by the customers.

The problem is also solved by a method for handling a queue at store checkout counters and similar, wherein two or more checkout counters have one common single-line customer queue. The method comprises the steps of: indicating the occurrence of a specific triggering event associated with transaction events from a checkout counter, automatically indicating a change in status for the checkout counter based on the transaction event, sending a signal from a central processing unit to a display arranged within sight of the queue that displays the status of all connected checkout counters, and displaying the new status of the checkout counter on the display.

Further advantageous embodiments of the invention have been specified in the dependent claims.

### BRIEF DESCRIPTION OF THE DRAWINGS

The invention will in the following be further described, in a non-limiting manner, and with reference to the accompanying drawings, in which:

FIG. 1 shows a schematic representation of a director system at a supermarket checkout according to an embodiment of the present invention,

FIG. 2a shows a display to be used with the director system of the invention,

FIG. 2b shows the display in FIG. 2a in use with the director system of the invention,

FIG. 3 shows a flow diagram describing the procedural steps according to the present invention,

FIG. 4 very schematically illustrates the connection between checkout counter, CPU and display according to the invention.

### DETAILED DESCRIPTION

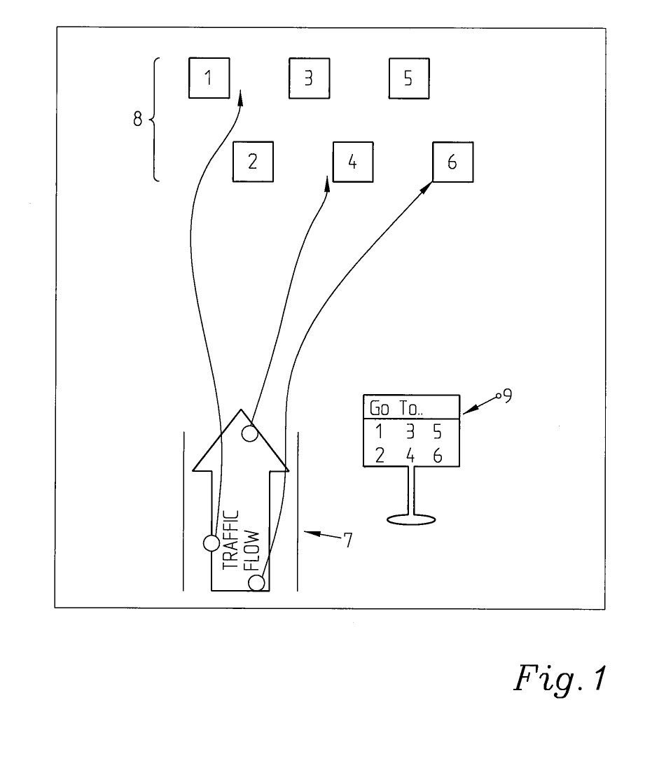

FIG. 1 shows a schematic representation of a director system at a supermarket checkout according to an embodiment of the present invention. The supermarket style checkouts are arranged in clusters of normally 4-8 checkout counters 1,2,3,4,5,6. Even though each checkout cluster can include more than 8 or less than 4 checkout counters. Customers wait for service in one queue 7 per checkout cluster 8. There could be several such clusters in a large store depending of the number of checkouts. At the front of the queue there is a display 9 showing each of the checkouts 1-6.

The display 9 has preferably each checkout counter 1-6 marked just as they are physically located in the store. In order to indicate to the next customer in line to proceed to a checkout counter, the number of the checkout counter could be arranged to flash until said customer has arrived at the checkout counter.

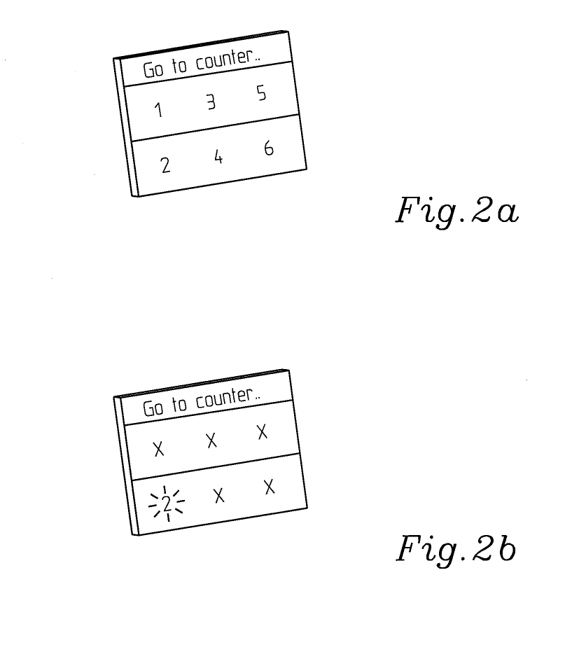

FIG. 2a shows a display to be used with the director system of the invention. According to a preferred embodiment, the display 9 is provided with different signs displaying the status of the respective checkout counters 1-6. Each number displayed represents the corresponding counter number. The display is capable of presenting multiple colours and can be programmed to blink individual numbers. See e.g. FIG. 2b showing the display in use. A location marked with an amber X means that the corresponding checkout counter is busy serving a customer and a location marked with a red X means that the checkout is closed. When a number “2” is blinking this means that the checkout counter is open and that the next customer should proceed to said checkout. Audio alerts and further blinking lights may also be employed.

The next customer is called by the cash register automatically sending a signal to the CPU when the previous customer's trans-action is completed and the number of that checkout starts flashing on the display for a pre-determined period of time, normally a few seconds. If the next customer in line doesn't pay attention when the number is flashing the cashier can call it again manually by pressing a button on the cash register. Another option is that the number flashes until the first item is scanned. After that the display will show an amber X for that checkout until the transaction is completed. When the cashier closes the cash register for a break or to leave his/her shift the cash register will automatically send a signal to the CPU which will show a red X on the display until it is opened again and will call a customer by flashing the checkout number on the display.

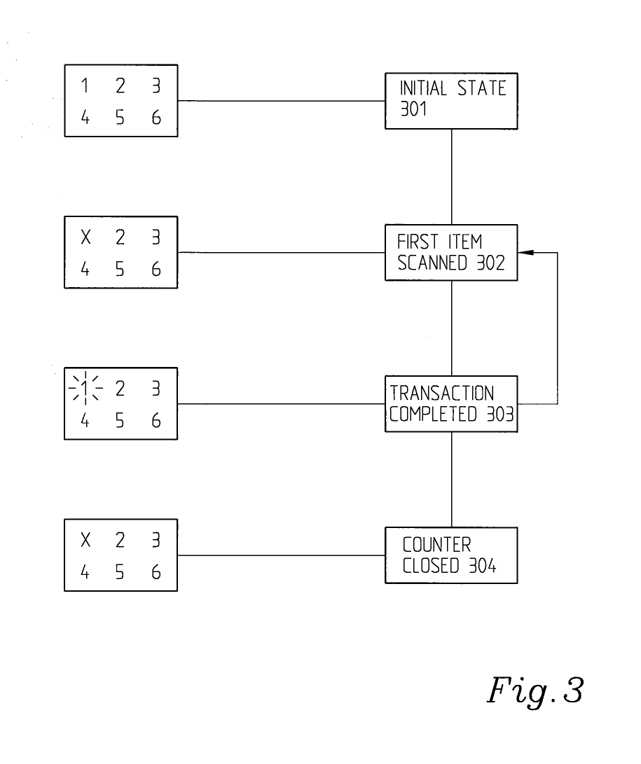

FIG. 3 shows a flow diagram describing the procedural steps according to the present invention. In the initial state 301, as shown in FIG. 2a, the display shows the status for all checkout counters 1-6 of the checkout cluster connected to the system. In this particular case all checkout counters are available. When a customer arrives at the checkout counter 1 and a triggering event associated with the transaction to take place occur, a signal is automatically sent to a central processing unit (CPU) in control of the display 9. The event triggering the transmission of the signal is preferably the scanning of the first item by the cashier or by an automated point-of-sale checkout system. The event could also be the arrival of the customer to the checkout counter, detected by means of sensors or similar, or reading of an RFID tag carried by the customer. The CPU informs the display of the event and the customers in queue are informed that the checkout counter is occupied serving a customer by automatically exchanging the previous number “1” to e.g. an amber X, whereby the display enters an occupied state 302 for counter 1. When all items are scanned and the transaction is completed this triggers the sending of another signal to the CPU. The CPU informs the display of the event and the number “1” of said checkout counter starts flashing on the display for a pre-determined period of time, whereby the display enters an available state 303 for counter 1. This state normally lasts a few seconds, but if the next customer in line doesn't pay attention when the number is flashing the cashier can call it again manually by pressing a button on the cash register. The preferred option is however that the number flashes until the first item is scanned for the newly arrived customer. After that the display will enter the occupied state 302 for checkout counter 1 and show an amber X for this counter until the transaction is completed. Thereafter the counter 1 alternates between the occupied state 302 and the available state 303 until the cashier closes the counter. When the cashier closes the cash register/checkout counter for a break or to leave his/her shift the cash register will automatically send a signal to the CPU which then will inform the display to indicate this by e.g. showing a red X, whereby the display enters a closed state 304 for counter 1 until it is opened again and will call a customer by flashing the checkout number on the display.

The event triggering the conversion from occupied 302 to available 303 state is preferably a transaction event, such as the event when the cashier informs the cash register that all items have been scanned. The checkout counter is provided with means for automatically informing the CPU of the occurrence of the specific triggering event associated with the transaction event. Thereby the next customer will, most probably, arrive at the checkout counter when payment is still being made and can then start to unpack his or hers shopping trolley or shopping bag while the customer already at the checkout counter is completing his transaction. The event can also be that the transaction is completed, i.e. payment has been accepted and/or a receipt has been printed.

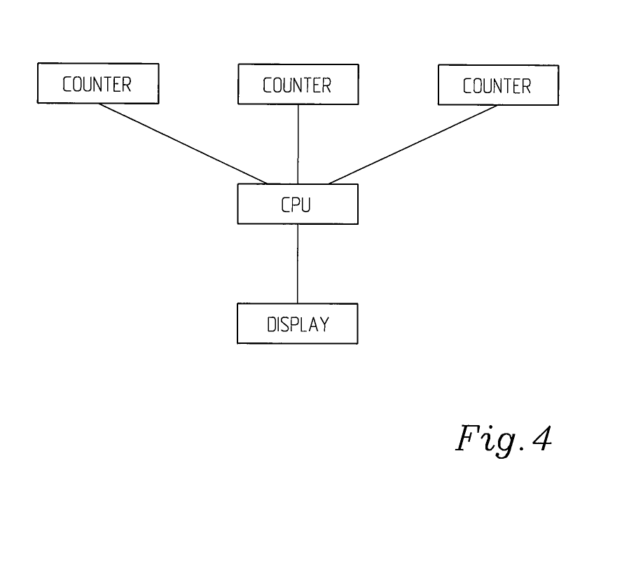

FIG. 4 very schematically illustrates the connection between the different devices included in the system. All checkout counters 1-6 are connected to a central processing unit (CPU) processing all the information received from the checkout counters regarding status etc. The CPU is further connected to the display and controls the same. The transmission of information between the devices can be carried out with wires or wirelessly using IR or Bluetooth or similar communication means. The system will require an integration/interface between the cash register/checkout counter and the CPU which will be custom developed for each type of cash register system used. As illustrated in the drawing the CPU is located separate from the counters and the display. It should however be clear that the CPU can be integrated with a counter or all counters can be provided with their own CPU, thus communicating directly to the display.

Currently more and more supermarkets tend to use one or more checkout counters in the form of automated point-of-sale checkout counters. An automated retail point-of-sale checkout counter has the ability to allow consumers to check out their purchases with a minimal of direct human assistance. The consumer scans himself the items to be purchased when at the checkout counter and pays accordingly. The checkouts possess security features which deter customers from fraudulently bagging items by comparing the weight changes on the packing scale with the product number related information in the case of labelled products. Some supermarkets also use another version of self scanning in which the consumer scans the products he intend to buy before putting the product in his shopping trolley. When the consumer arrives at the checkout counter all products have already been scanned and the consumer merely has to pay, thus decreasing the time spent at the checkout counter. Consumer using these self scanning systems uses checkout counters separate from ordinary checkout counters. In the system according to the present invention these checkout counters could be treated as a separate checkout cluster with a separate display and a separate queue for only the self scanning checkouts. They could however also be integrated in ordinary checkout clusters, but then the display should indicate which checkout counters that are provided with self scanning features, e.g. with other colours, so that consumers aren't mislead.

It should be clear that the invention is not limited to the specifically illustrated embodiments but that it can be varied in a number of ways within the scope of the appended claims, the system is for instance not limited to use in supermarket checkouts but can be used in airports, bank establishments, post offices and other places where queues need to be handled.

1. System designed for handling a queue at store checkout counters and similar, wherein two or more checkout counters have one common single-line customer queue and wherein one or more central processing units are arranged to control a display arranged within sight of the queue, the display displaying the status of all connected checkout counters and thereby indicating to the next customer in the queue to proceed to an available checkout counter, wherein the checkout counters and the central processing units are interconnected such that the display, upon the occurrence of a specific triggering event associated with a transaction event from a checkout counter, is arranged to automatically indicate a change in status and update the status for said checkout counter.

2. System according to claim 1, wherein said transaction event is the event when the cashier informs the cash register that all items have been scanned.

3. System according to claim 1, wherein said transaction event, is the event that determines that a transaction is completed.

4. System according to claim 1, wherein a further transaction event is the scanning of a first item for a new customer.

5. System according to claim 1, wherein sensor means is arranged to detect the presence of a new customer at the checkout counter which triggers the display to indicate a change in status and update the status for said checkout counter.

6. System according to claim 1, wherein said display is adapted to indicate the positions of the checkout counters.

7. System according to claim 1, wherein means are provided for a cashier to manually indicate a change in status and update the status for said checkout counter.

8. Method for handling a queue at store checkout counters and similar, wherein two or more checkout counters have one common single-line customer queue, the method comprising the following steps: indicating the occurrence of a specific triggering event associated with a transaction event from a checkout counter; automatically indicating a change in status for the checkout counter based on the transaction event; sending a signal from a central processing unit to a display arranged within sight of the queue and displaying the status of all connected checkout counters; and displaying the new status of the checkout counter on the display.

9. Method according to claim 8, wherein said transaction event is the event when the cash register is informed that all items have been scanned.

10. Method according to claim 8, wherein said transaction event is the event that determines that a transaction is completed.

11. Method according to claim 8, wherein a further transaction event is that the first item for a new customer is scanned.

12. Method according to claim 8, wherein sensor means is arranged to detect the presence of a new customer at the checkout counter which triggers the display to indicate a change in status and update the status for said checkout counter.

13. Method according to claim 8, wherein said display is adapted to indicate the positions of the checkout counters.

14. Method according to claim 8, wherein means are provided for a cashier to manually indicate a change in status and update the status for said checkout counter.
